(19) United States
(12) Patent Application Publication
(10) Pub. No.: US 2015/0278888 A1
(43) Pub. Date: Oct. 1, 2015

(54) SYSTEM AND METHOD FOR ACQUIRING INFORMATION

(71) Applicant: Branding Brand, Inc., Pittsburgh, PA (US)

(72) Inventors: Allen LU, Pittsburgh, PA (US); Chris Mason, Pittsburgh, PA (US); Scott Dunlap, Pittsburgh, PA (US); Carl Evankovich, Pittsburgh, PA (US); Schuyler E. Eckstrom, Pittsburgh, PA (US); Bassel Elias Dagher, Pittsburgh, PA (US); Haoran Lui, Pittsburgh, PA (US)

(73) Assignee: Branding Brand, Inc., Pittsburgh, PA (US)

(21) Appl. No.: 14/228,500

(22) Filed: Mar. 28, 2014

(51) Int. Cl. G06Q 30/06; G06Q 30/02

(52) U.S. Cl. CPC G06Q 30/0601; G06Q 30/0267

(57) ABSTRACT

A method for acquiring analytical information may be provided. The method may include providing a database configured to store user specific data and providing a user interface for displaying, inputting, or analyzing the data. A customer interface may be provided to allow for customer interaction with a business, retailer, or service provider. Customer data may be measured through online interactions, signals from mobile devices, and in-store interactions. User specific data and general customer data may be compiled in the database and feedback may be generated based on the data and presented through the user interface.

### BACKGROUND

Transactions and interactions with products, services, and advertisements by customers can take on various modes for purposes of acquiring said products and services. Traditionally, customers can purchase and interact with goods and associates at physical stores, such as supermarkets, department stores, and the like. In addition, the increased prevalence of on-line shopping has created a viable and readily available alternative for customers to obtain nearly any good or service from the convenience of a personal computer or mobile device.

From a physical or “brick and mortar” retailer or service provider's perspective, insight into a customer is only obtained when the customer is in the store, most often after the transaction has been completed at the point-of-sale. This information, however, does not provide customer behavior and preferences before the purchase took place. Should the retailer or service provider have an online shopping portal, information collected about each customer's online interactions may not be linked back to that customer's in-store interactions until, at best, after an in store transaction has taken place. Additionally, cash transactions may not be tracked or linked to a customer at all.

### SUMMARY

A method for acquiring information may be provided. The method may include providing a database configured to store user and customer data and providing a user interface for displaying, inputting, or analyzing the data. A customer interface may also be provided to allow customer interaction with at least one of products, promotions, customer service representatives, businesses, retailers, service providers, and in-store environments. The customer interface or user interface may comprise a mobile device. A user may communicate at least one of product information, promotions, advertisements, customer service, and store information to a customer. Customer data may be collected through online interactions, signals from mobile devices, and in-store interactions. User specific data and general customer data may be compiled in the database and feedback may be generated based on the data and presented through the user interface.

Further, a system for acquiring information may be provided. The system may include a database configured to store individual and general customer data. The system may also include a network and a user interface for displaying and inputting data. A customer interface may be included for interacting with at least one of products, ID tags, beacons, promotions, customer service representatives, businesses, retailers, service providers, and in-store environments. The system may further include an in-store environment with at least one product, at least one ID tag, at least one beacon, and in-store hardware.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 may show a diagram of the components of an exemplary embodiment of a system and method for acquiring information.

FIG. 2 may show a diagram of an exemplary embodiment of a system and method for acquiring information.

FIG. 3 may show an exemplary flow chart of a system and method for acquiring information.

FIG. 4 may show an exemplary embodiment of a customer location tracking system.

FIG. 5 may show an exemplary flow chart for customer location or interaction triggered business actions.

FIG. 6 may show an exemplary flow chart for sending targeted messages and recording customer data.

### DETAILED DESCRIPTION

Aspects of the present invention are disclosed in the following description and related figures directed to specific embodiments of the invention. Those skilled in the art will recognize that alternate embodiments may be devised without departing from the spirit or scope of the claims. Additionally, well-known elements of exemplary embodiments of the invention will not be described in detail or will be omitted so as not to obscure the relevant details of the invention.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

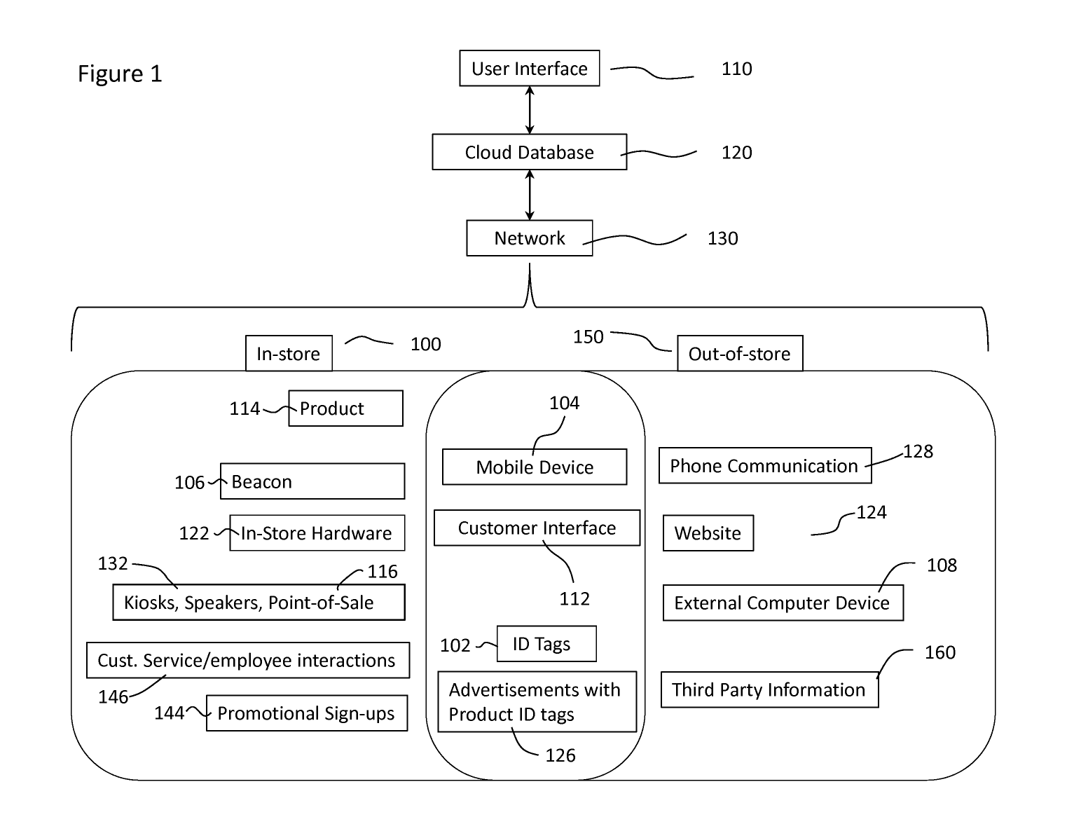

Referring generally to FIGS. 1-6, a system and method for acquiring analytical information may be provided. A wealth of knowledge and data may be available through online and in-store customer interactions. Similarly, additional knowledge and data may be available through associate interactions. A process for acquiring analytical information in an in-store environment 100 may utilize in-store triangulation, Wi-Fi, Wi-Fi Positioning System, mobile, and web technology to identify unique customers and customer households and their interactions via online and traditional brick-and-mortar stores to bridge the three variables into one cohesive ecosystem. An exemplary embodiment may be employed in various industries, including retail and service industries.

Still generally referring to FIGS. 1-6, retailers and service providers may gain a better understanding of each customer's unique persona 118, for example preferences, sizes, price range, behaviors and the like, and may offer custom offerings that better suit the interests of each unique customer as opposed to common “spam” advertising. Retailers and service providers may also better track the effectiveness of advertising, particularly digital advertising, for driving foot traffic. Behavior may include where a customer spends time in a store. Behavior of store associates may also be monitored and analyzed. In an exemplary embodiment, location behavior within a store may be analyzed with heat mapping. In addition, purchases made online via a mobile device 104 whilst the customer is in the store can be identified and credited to the store, such as in-store sales associate's commission, store-specific sales metrics and the like. As used herein, the term “mobile device” 104 may refer to a personal mobile device possessed by a customer such as the customer's mobile phone, smart phone, mobile tablet, and the like.

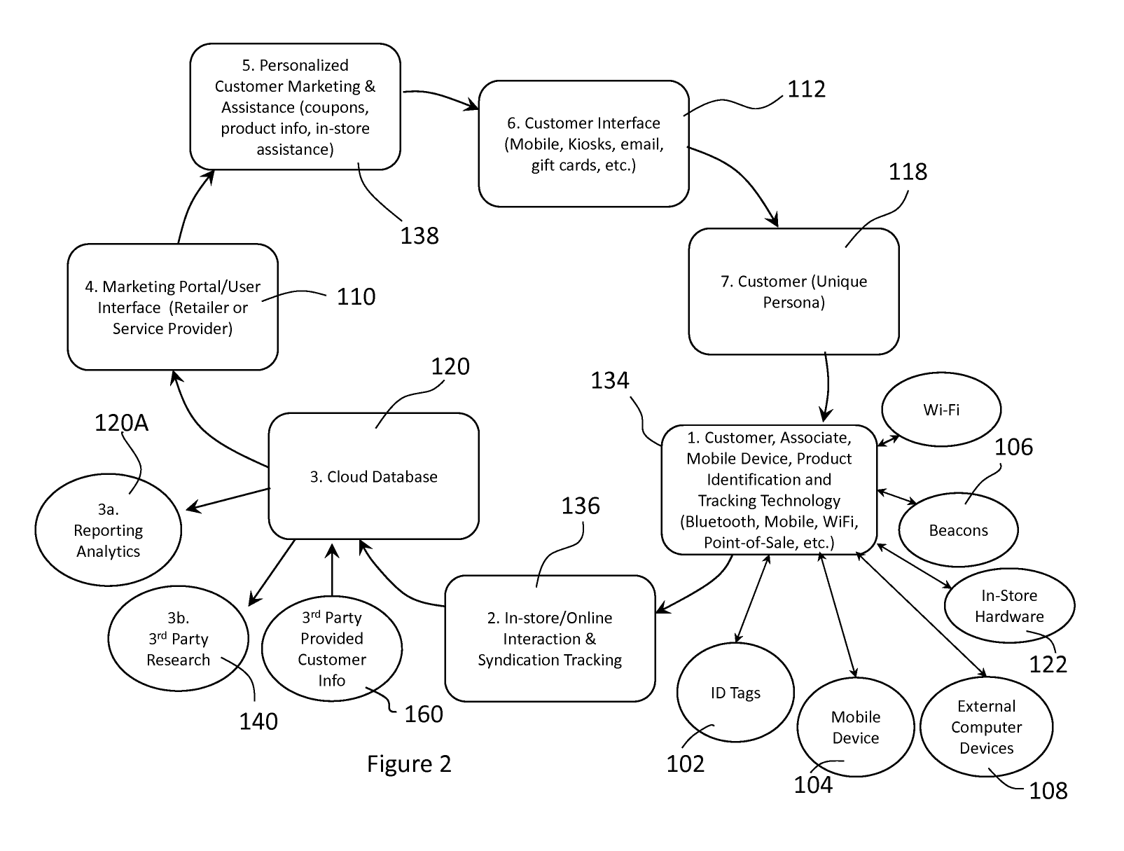

Referring to FIGS. 1 and 2, a process for acquiring analytical information in an in-store environment 100 may provide a system and method for acquiring insight based on actions within a brick-and-mortar in-store environment 100 as well as external environment 150. Exemplary activity outside of a brick-and-mortar environment 100 may include activity on a mobile device 104 outside of the in-store environment 100, activity on an external computer device 108, activity on a webpage 124, interactions with ID tags on advertisements 126, phone communication with a retailer or service provider 128, interactions with third parties 160, and other activity that may interact with a service provider, retailer or its representative outside of the in-store environment 100. An external computer device 108 may include a computer device that is outside of an in-store environment 100, such as a personal computer at a customer's home. The external computer device 108 may allow interaction with a retailer or service provider through applications, programs, the internet, or other networks. Some exemplary embodiments of the system and method for acquiring information may be configured so as to use computer applications such as mobile device 104 applications. In an exemplary embodiment, a user of the system and method may include a retailer, service provider, business, store or similar entity and its associates. A user interface 110 or dashboard may be provided to a user or third party for manipulating, retrieving, displaying, and analyzing data. A customer may also have a customer interface 112 that allows them to access and interact with a retailer, service provider, or business and the customer interface 112 may record customer data, which may include biographical data, location data, online interaction data, and physical interaction data. Customer interface 112 may include an application or program on a mobile device 104 or external computer 108, a website, in-store kiosks 132 or audio systems, and the like. A system may enable the analysis of customer behavior that occurs prior to a purchase transaction, regardless if it's via physical interaction or online (web) interactions. For example, a system may be used to identify offers or products 114 for which a customer showed interest prior to a purchase or in the absence of a purchase. A system may be used to identify information, such as product reviews, that a customer may have accessed to inform a possible purchase decision. A system also may be used to track customer location and foot traffic within the in-store environment 100. Additionally, a customer insight system may be used to initiate personalized customer interactions such as targeted advertising and product offers, product information, customer assistance, and the like. A system may also track special offers or coupons that a customer uses or may track products 114 customers interact with subsequent to advertisements for that product. This tracking may lead to more productive promotions and targeted advertising. Sales volume may also be better attributed to specific advertising based on collected customer interactions. The personalized customer interactions may be initiated by the customer or initiated based on analysis of the customer information collected by the detailed system and method.

FIG. 2 shows a design flow of an exemplary embodiment of a process for acquiring information, which may use the components provided in FIG. 1. This may include monitoring customer interactions with products 114 through in-store and online interaction and syndication tracking 136. Customer and product identification and tracking technology 134 may be used to track 136 the interactions. The information may be collected and transmitted over a network 130 and may be stored on a database 120. In an exemplary embodiment, data may be collected over Wi-Fi. The information collected on the database 120 may be used for retailer, service provider, or business records, personalized marketing 110, 138, and generating a unique customer persona 118. But, it may also be used for third party research 140 and various reporting analytics 120A. In some exemplary embodiments, information and data may also be collected from or inputted by third parties.

Still referring to FIGS. 1 and 2, products 114 may include goods or services offered or promoted by a retailer or service provider. A customer interaction with a product 114 may include a customer purchasing, browsing, researching, or the like. Interactions may be monitored by measuring a customer's time spent in an area of a brick-and-mortar store or on a page of a website. Interactions may also be monitored by purchase information recorded at a point-of-sale 116 or online checkout. Another way interactions may be monitored may be through a customers' interaction with identification tags 102. Identification tags 102 may specifically include product identification tags, which may be on products, product packaging, or product advertisements. In some embodiments, there may be identification tags that are not attached or associated with a product. For example, there may be an identification tag placed within a store, such as near the front door. An identification tag such as this may be used to similarly monitor a customer's activity. The methods of identification of in-store products 114 associated with identification tags 102 can include standard printed labels, such as bar codes, as well as electronic tags such as radio frequency identification (RFID) tags, Bluetooth beacons and the like. These tags 102 may encode information about a tagged product 114 by reference or by value. If an identification tag 102 encodes information by value, the tag 102 itself may include a variety of product information, including a unique product identifier, relation to the store location, product specifications, in-store inventory, product offers and discounts, product reviews, advertisements and the like. A variety of techniques may be used to scan tags 102. A camera on a mobile device 104 may be used to capture an image of the identification tag 102, which may be a bar code, for example. The mobile device 104 can then convert the image of the identification tag 102 into a product identifier that uniquely identifies the product 114. The mobile device 104 may include a laser scanner to scan bar codes, as well as RFID reader to read NFC or similar types of RFID signal.

RFID tags may be utilized in conjunction with Bluetooth low energy (BLE) devices. RFID tags may be placed on products within an environment, specific locations of a store, on associate name tags, etc. A RFID scanner, when within range of the tags, may scan or interact with each RFID tag. The RFID signal may then scan or interact with the RFID tag to collect preset information within the tag such as Product type, location, pricing, store/associate name, promotions, etc. A process within the scanner or a separate computing device which receives the RFID Signal may convert the signal to Bluetooth or Bluetooth low energy (BLE). This may allow RFID signals to be converted to a signal to be received by devices that do not traditionally support RFID signals (certain cell phones, computers, kiosks, etc).

The act of scanning an identification tag 102 may also include the user manually entering a product code displayed on the product 114 or identification tag 102. Other interactions may include beacon 106 activated app notifications on a mobile device 104. Similarly, interactions may be determined through a Wi-Fi based Positioning System or Wi-Fi based triangulation. Wi-Fi based positioning may also trigger app notifications on a mobile device 104. This may be specific customer requests with regard to a product 114 such as a request for product information, product reviews, customer assistance, and the like. Yet other tracked interactions may include promotional sign-ups 144 and customer service or employee interactions 146.

In conjunction, devices utilizing Bluetooth may be used to affix directly to products 114, groups of products, or sections of the in-store space covering a large area. The beacons can be placed throughout the in-store space without being directly affixed to a product. Points of interest, such as a product display, may be targeted through triangulation with the beacon signals. This may allow multiple points of interest to be targeted with beacons and it may allow modifications to points of interest without replacing beacons. The points of interest may be changed programmatically. These “beacons” 106 may each have a unique identifier that distinguishes that beacon 106 from others. An example may be specific UUID (Universally Unique Identifier) characteristics within the Bluetooth protocol. These unique signals may broadcast within a configurable range to allow identification of customers within the brick-and-mortar space through their personal mobile devices 104. The beacon's signal, when detected in range of these mobile devices 104, may trigger an array of information on the customer's mobile device 104, including promotions of nearby products 114, coupons, advertisements, recommendations, video demos, customer assistance and the like. The personalized customer marketing and assistance 138 may be triggered by beacons, product interactions, customer specific data, and the like.

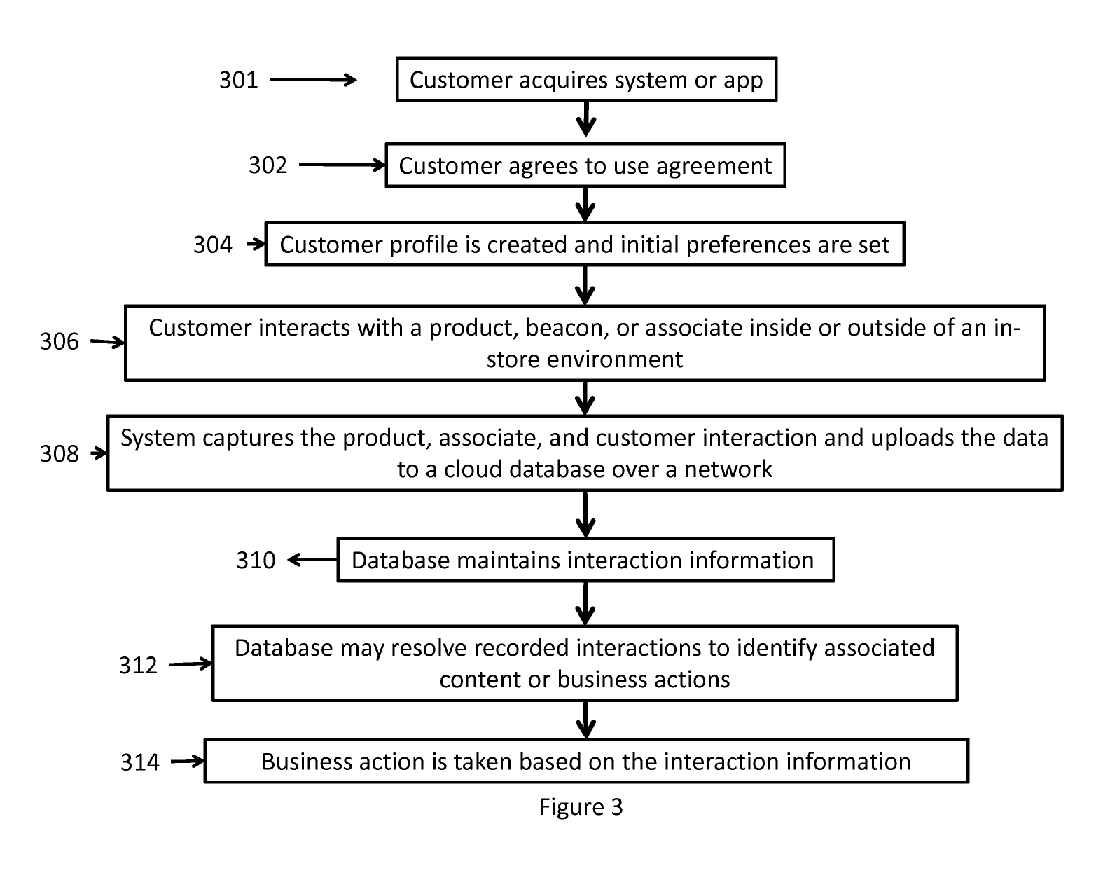

Referring to FIG. 3, a customer may acquire a system or app 301. The customer may opt-in or agree to a use agreement as shown in step 302. In 304, the customer may create a profile and set initial preferences. The mobile device 104 may communicate information to the database 120 such as device and user identity and user profile information. Next 306, the customer may interact with a product or beacon inside or outside of an in-store environment. In 308, the customer's mobile device 104 may communicate interactions within the store to a cloud hosted electronic database 120. The network 130 may be any suitable type of wireless communications network, including a Wi-Fi network based on the IEEE 802.11 standards, or a cellular general packet radio service (GPRS) network, among others as would be understood by a person having ordinary skill in the art. In 310, the database 120 may store and maintain customer interaction information. The database 120 may be configured to maintain the integrity and security of the interaction information. Further in 312, the database 120 may resolve a particular interaction by the customer to identify content or business actions corresponding to a product 114, such as product offers, advertising media, and the like. Each product interaction may be used to determine a business action to be performed by the user or database 120, as shown by 314. Exemplary business actions include sending a set of product-related content to the customer's mobile device 104, initiating in-store advertising, and the like.

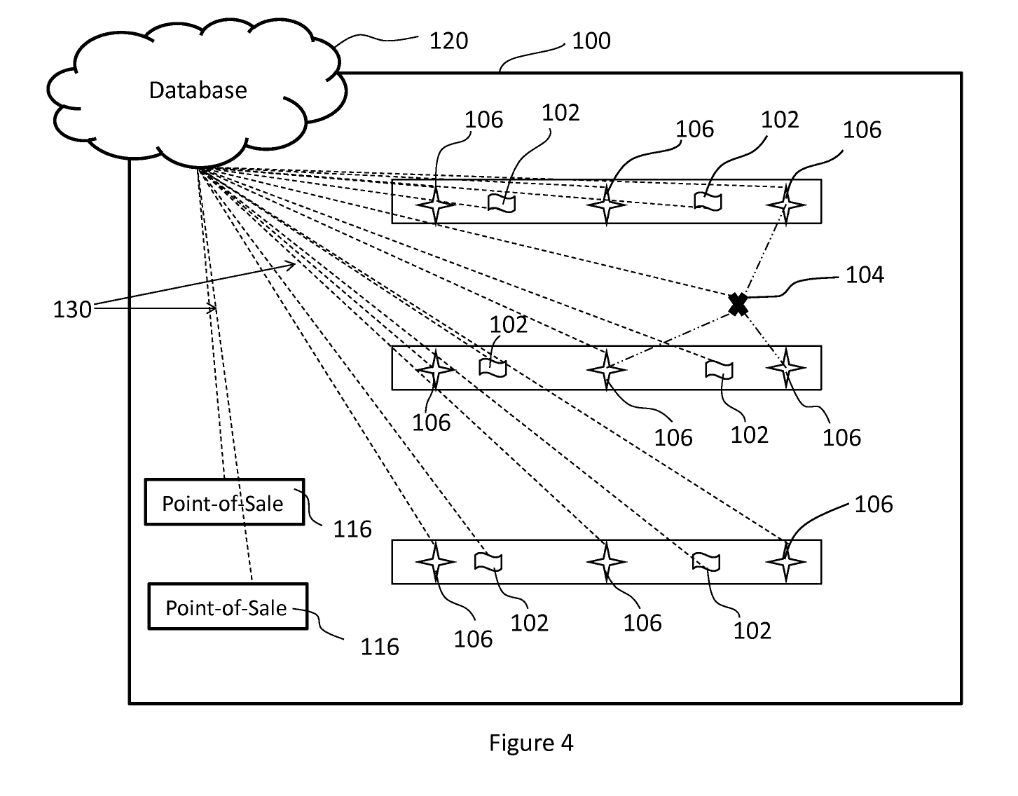

Now referring to FIG. 4, a customer's interactions within a store may also be used to determine the location of a mobile device within that in-store environment 100. In an exemplary embodiment, the mobile device may be a customer's mobile device. The system/database may compare beacons 106/mobile devices 104/RFID signals (tags 102)/Wi-Fi signals and triangulation and the like in relation to one another as well as to the store layout in order to accurately identify user location within the in-store environment 100 and approximate the direction and speed the user may be moving. In some exemplary embodiments where a customer's mobile device is equipped with a gyroscope, gyroscope data may be used in the analysis to enhance accuracy or reduce battery usage. This may provide an advantage over or supplement traditional locating techniques such as global positioning systems (GPS) and cellular triangulation, which may not perform well in typical in-store environments 100 due to a lack of sufficient resolution and interference with the line-of-sight signals used in such technology. The location of the customer may be used to provide targeted product information, in-store advertising and customer assistance. Location information may also be aggregated over multiple users and analyzed to determine in-store traffic, store hot-spots, customer interest trending, and the like, to a greater level of accuracy than using only point-of-sale 116 data. In an exemplary embodiment, data from a gyroscope, beacon based positioning, Wi-Fi based positioning, cellular based positioning, and GPS based positioning may be collected and analyzed to determine a location of the mobile device.

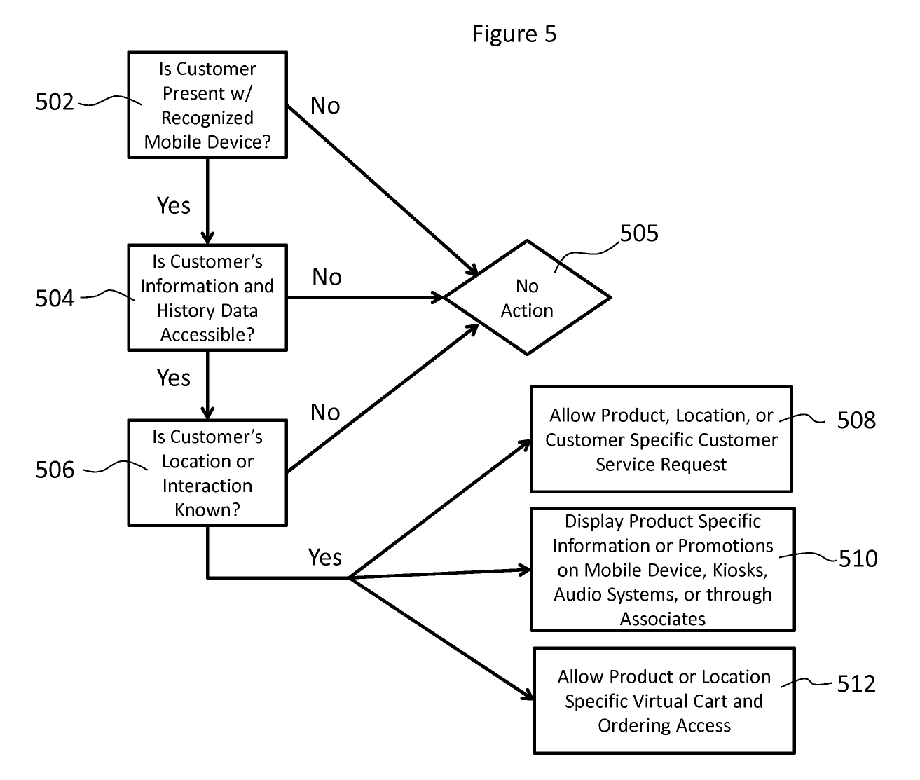

Now referring specifically to FIG. 5, a system and method for acquiring information may be used to initiate various business actions based on a customer's interactions with specific products 114. Business actions may be directed to a specific customer in response to a product interaction of that customer. In some exemplary embodiments, anonymous customers may be tracked and business actions may be taken based on anonymous customer interaction information. Information received from the process may be interpreted by an application installed on a mobile device 104 and when a customer interacts with a product 114 using their mobile device 104 (via RFID/barcode scanning) or when their mobile device 104 is within range of a specifically determined beacon 106 (based on unique beacon identifiers such as the UUID); a dynamic or preset display may be presented on the customer's mobile device 104 via the graphical user interface. In step 502, the presence of the customer with a recognized mobile device in an in-store environment may be determined. If no customer and recognized mobile device is present, no action 505 may be taken. Next 504, it may be determined if a recognized customer's information and history data is accessible. If not, no action 505 may be taken. If the recognized customer's information is accessible, it may be determined if the customer's location or current product interaction is known. If unknown, there may be no action 505 to be taken. If known, an optional initial menu/prompt may be presented which provides basic information about the product 114 such as a name of the product, product pricing, customer reviews and ratings, or seasonal/promotional offers and the like 510. The initial option menu may also provide menu options that enable the user to obtain more detailed information, such as product specification, customer reviews, and offers related to the product 114, such as personalized pricing discounts, coupons, sales, and the like 510. Some embodiments may include allowing the user to select an option for adding the product 114 to a virtual shopping cart or wish list 512. The virtual shopping cart or wish list may be used to identify products 114 that the customer intends to purchase, or would like to purchase in the future. Orders may be placed within the store, via a mobile device 104 and the goods may be picked up at a pre-determined location within the store or shipped to the customer. Other interaction examples may include the ability for the customer to request customer service 508. The request for customer service may be sent to a database 120, which then uses the location information to dispatch a customer service agent to the customer location within the in-store environment 100. User data may be provided to the customer service agent through the system, so as to provide customer identification and user history and preferences to allow for more targeted assistance. Additionally, passive movement tracking may be used to identify customers who may be in need of customer service. For example, if a customer stalls in an area of the store, the customer may be identified as possibly in need of customer service and a store associate may be alerted to assist the customer.

Still referring to FIG. 5, the system and database 120 may also collect and evaluate recent product interactions of several customers within the vicinity to select advertising content to be displayed on one or more in store displays or kiosks 510. In addition, an announcement may be played over an audio system within the vicinity of the customer 510. Information from a user's profile, his/her location in the store at that instant of time, the relative location of in-store traffic at that instant of time, recent product interactions, customer requests, and business rules may be taken into account to determine a business action.

A database 120 and in-store hardware 122 may communicate and log each product interaction to build a knowledge base about each specific customer based the customer's unique identifiers. This may include the unique device ID within their mobile device 104, store memberships, email addresses and the like. The database 120 and hardware 122 may be store specific in some embodiments, but not other embodiments. The database 120 and hardware 122 may be configured in the store or remotely. This knowledge base can be used to provide personalized content to a customer based on the known interests and purchasing habits of the customer. The knowledge base may also be used to determine a business strategy based on the knowledge acquired from customers. The system may manage information regarding specific customers and enable a user to provide a more personalized shopping experience. For instance, a user profile may include personal information provided by the customer. Such information may be gathered as part of a service registration process conducted when the user downloads a mobile device application or signs up for a membership or loyalty card. The customer may be requested to provide a mailing address, billing information, contact information, and the like. The customer may also be requested to provide information regarding personal preferences, demographic information, and the like. Data may also be collected via a questionnaire that asks the customer to indicate brand preferences, product preferences, age, income level, occupation, and the like. In some exemplary embodiments, the information may be automatically obtained through data stored on a customer's device or through a third party.

The user profile may include previous product interactions or sales associate interactions of the customer as well as derivative information such as the customer's likes and dislikes. For example, previous purchases by the customer may be used to determine that the user tends to favor particular brands or manufacturers, and this information can be stored to the user profile. The user profile may also include information acquired through an online customer account registered through a Website provided by the retailer, service provider, or business. In this way, online purchases and activity of the customer may be added to in-store activity, providing a full analysis of the customer's shopping habits.

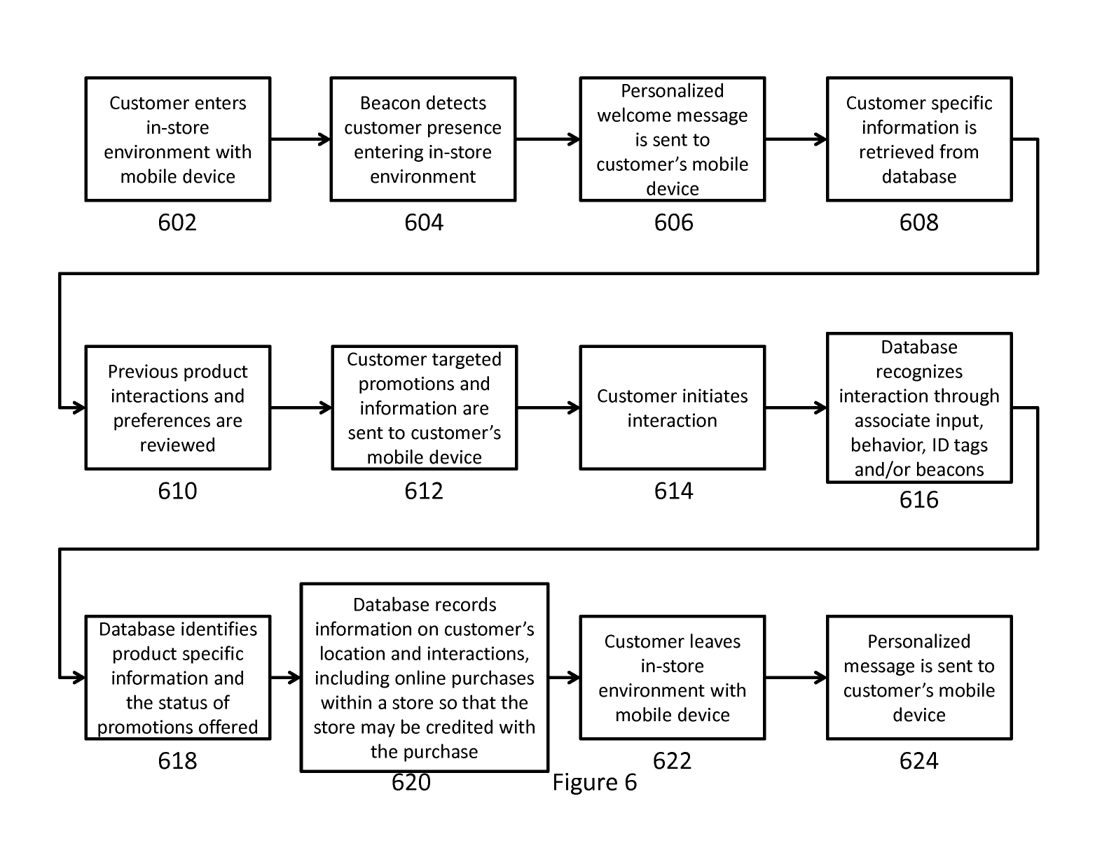

Now referring to FIG. 6, when a customer initiates a product interaction, the database may identify specific product information to send to the mobile device 104 based, in part, on knowledge about the customer provided by their database profile. For example, the database may trigger a welcome message 606 to the mobile device 104 that includes the customer's name when they walk through the entrance 602, via detection 604 by a beacon 106 placed at the entrance. The database may also trigger a goodbye message 624 when the customer walks out 622 of the store, via the same method. In steps 610-612, the database may also alert a specific customer regarding a price discount available for a specific product 114 in which the user has shown a previous interest, which may be determined based on a previous product scan, request for reviews, addition of the item to the user's shopping cart or wish list, and the like. The database may alert a customer to similar products available online based on a customer's in-store interactions or behavior, such as spending time in a certain aisle or product location. Similarly, the database may alert a customer to in-store locations of similar products based on a customer's online interactions.

The system and method may also include an analytics database 120A that may perform analysis on data gathered. The database 120A may identify products 114 that customers were interested in but didn't purchase. This may be accomplished by recognizing product interactions through product tags or beacons 616. In steps 618-620, the database 120A may also identify product offers and promotions that users redeemed or were interested in but chose not to redeem. The database 120A may also identify the types of information requested by customers to inform their purchasing decisions. Further in 620, the database 120A may analyze foot traffic within the in-store environment 100 based on the combined location information and user profile information of individual and groups of customers. For example, a database 120A may be used to determine how many people are in the store during certain periods of the day, the demographic characteristics of customers and how those demographics vary throughout a day, the length of time customers remain in the store, what products 114 the customers interacted with, the popular/unpopular locations based on where customers spend the most time (heat-mapping), as well as patterns that may be taken as they walk through the store. This information may be used, for example, to alter product pricing or to design a marketing campaign with regard to certain products 114 or relocate certain products 114 and store layout. The location and interaction data recorded in step 620 may also be used to identify online purchases placed within an in-store environment so that the brick and mortar store may be credited with the purchase.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method for acquiring information comprising:
providing a database configured to store individual and general customer data;
providing a user interface for manipulating, retrieving, displaying, and analyzing individual and general customer data, wherein a user comprises a retailer, business, or third party organization;
providing a customer interface for interacting with at least one of products, promotions, advertisements, customer service representatives, businesses, retailers, service providers, and in-store environments, wherein a customer comprises a consumer or shopper;
determining a communication comprising at least one of product information, promotions, advertisements, customer service, and store information based on individual or general customer data;
communicating the communication to at least one customer via a customer interface, wherein the customer interface comprises at least one of a mobile device, in-store display, or audio system, as determined by customer in-store location data;
collecting customer data through signals from mobile devices, in-store interactions, and out of store interactions, wherein customer data comprises in-store location data, online browsing data, advertisement interaction data, non-purchasing product interaction data, and product purchasing data;
compiling individual and general customer data in the database;
generating feedback based on the data, wherein the feedback comprises reports showing customer interactions with products not later purchased by the customer and customer interactions with products later purchased by the customer;
displaying the feedback through the user interface; and
attributing online sales to brick and mortar store locations based on individual customer data.

2. The method of claim 1, further comprising tracking the location of a customer within an in-store environment through at least one of mobile device signals and recorded product interactions.

3. The method of claim 1, further comprising recording information about products a customer scans or searches with a mobile device.

4. The method of claim 1, wherein the measuring of customer data further comprises tracking online customer purchases.

5. The method of claim 4, further comprising recording a customer's in-store interactions with a good the customer ultimately purchased online.

6. The method of claim 1, further comprising recording information regarding online purchases by a customer located within an in-store environment, through mobile device tracking and online purchase data.

7. The method of claim 1, wherein the customer interface is an application on a mobile device.

8. The method of claim 1, further comprising measuring and analyzing the traffic and patterns of customers within an in-store environment.

9. The method of claim 1, further comprising allowing a user to initiate a business action based on the collected data.

10. The method of claim 9, wherein the business action includes sending targeted promotions or advertisements to customers based on user specific data or general customer data.

11. The method of claim 1, further comprising providing a customer service request through the customer interface.

12. The method of claim 1, further comprising providing beacons within an in-store environment for tracking customer location and interactions.

13. The method of claim 1, further comprising recording data based on a customer scanning an identification tag.

14. A system for acquiring information comprising:
a database, configured to store individual and general customer data;
a network;
a processor; a user interface for manipulating, retrieving, displaying, and analyzing individual and general customer data, wherein a user comprises a retailer, business, or third-party organization;
a customer interface for interacting with at least one of products, promotions, customer service representatives, businesses, retailers, service providers, and in-store environments, wherein a customer comprises a consumer or shopper; and
an in-store environment comprising at least one product, at least one beacon configured to provide at least one of in-store location data or promotional data during interaction with a customer interface, and in-store hardware;
wherein the processor is configured to,
determine a communication comprising at least one of product information, promotions, advertisements, customer service, and store information based on individual or general customer data,
communicate the communication to at least one customer via a customer interface, wherein the customer interface comprises at least one of a mobile device, in-store display, or audio system, as determined by customer in-store location data,
collect customer data through signals from mobile devices, in-store interactions, and out of store interactions, wherein customer data comprises in-store location data, online browsing data, advertisement interaction data, non-purchasing product interaction data, and product purchasing data,
compile individual and general customer data in the database,
generate feedback based on the data, wherein the feedback comprises reports showing customer interactions with products not later purchased by the customer and customer interactions with products later purchased by the customer,
display the feedback through the user interface, and
attribute online sales to brick and mortar store locations based on individual customer data.

15. The system of claim 14, wherein the at least one product further comprises at least one product ID tag.

16. The system of claim 15, wherein the at least one product ID tag is at least one of a bar code, QR code, or RFID tag.

17. The system of claim 14, wherein the at least one beacon is a mobile computer device configured to transmit or receive over a wireless signal.

18. The system of claim 14, wherein the customer data comprises at least one of product interaction history, profile and biographical information, preference data, purchase history, location data, and promotion and marketing history and interactions.

19. The system of claim 14, wherein the customer interface comprises a mobile device.

20. The system of claim 19, wherein the mobile device is configured to communicate with the at least one beacon.
